(19) United States
(12) Patent Application Publication
(10) Pub. No.: US 2006/0288109 A1
(43) Pub. Date: Dec. 21, 2006

(54) Method and apparatus to facilitate Layer 3 internet protocol socket connections

(75) Inventors: Devarajan Puthupparambil, Mt. Prospect, IL (US); J. Schneider, Grayslake, IL (US)

Correspondence Address: FITCH EVEN TABIN AND FLANNERY, 120 SOUTH LA SALLE STREET, SUITE 1600, CHICAGO, IL, 60603-3406, US

(73) Assignee: UTStarcom, Inc.

(21) Appl. No.: 11/155,061

(22) Filed: Jun. 17, 2005

(51) Int. Cl. G06F 15/16

(52) U.S. Cl. 709/228

(57) ABSTRACT

A plurality of socket connections (comprising, at least in part, Layer 3 Internet Protocol connections) are established (101) and the aggregated (102) with respect to those Layer 3 Internet Protocol connections. In a preferred approach this does not comprise aggregating the socket connections with respect to any corresponding Layer 2 connections. Also in a preferred approach this aggregation comprises translating any of a variety of differing transaction protocols as are employed by various point-of-service terminals into a host-compatible transaction protocol.

### TECHNICAL FIELD

This invention relates generally to Internet Protocol-based communications and more particularly to Layer 3 Internet Protocol connections.

### BACKGROUND

Electronic transactions processing is known. Transaction processing supports, for example, credit card transactions, bank account fund transfers, and health records processing, to name but a few. In many cases a point-of-service terminal (including, for example, the nearly ubiquitous so-called point-of-sale terminal as is commonly used to facilitate retail credit and debit card transactions) serves as a point of initiation for such transactions with thousands or even millions of such terminals interacting over time with only a very few (relatively speaking) host servers. Most presently deployed point-of-service terminals utilize a dial-up link to establish a communications channel to such host servers. This approach has served well for decades and tends to be relatively quick as well as secure.

Notwithstanding the relative success of present practice in this regard, the ever-increasing scale, scope, breadth, and availability of extranets such as the Internet continue to pose new opportunities for reduced costs of operation, flexibility, scalability, speed of operation, reliability, security, upgradability, and the like. Increasing availability of broadband access in particular seems to be encouraging migration away from traditional dial-up techniques and towards all-Internet Protocol solutions for transaction processing. To accommodate such a shift, the point-of-service terminals themselves must most likely compatibly support Internet Protocol access. This, in and of itself, does not necessary pose a great challenge. This lack of apparent challenge, in turn, may be encouraging the aforementioned desire for an all-Internet Protocol transaction processing solution.

Unfortunately, present host servers represent an enormously valuable and costly investment. These servers are configured and arranged to interact in particular ways with respect to accepting, processing, and responding to transaction processing events. Simply replacing existing dial-up point-of-service terminals with Internet Protocol-capable appliances will not, in all likelihood, achieve sought-after benefits due at least in part to a large conflict between the likely operation of such terminals with the established legacy infrastructure that characterizes transaction processing.

### BRIEF DESCRIPTION OF THE DRAWINGS

The above needs are at least partially met through provision of the method and apparatus to facilitate Layer 3 Internet Protocol socket connections described in the following detailed description, particularly when studied in conjunction the drawings, wherein:

FIG. 1 comprises a flow diagram as configured in accordance with various embodiments of the invention;

FIG. 2 comprises a flow diagram as configured in accordance with various embodiments of the invention;

FIG. 3 comprises a flow diagram as configured in accordance with various embodiments of the invention;

FIG. 4 comprises a block diagram as configured in accordance with various embodiments of the invention;

FIG. 5 comprises a block diagram as configured in accordance with various embodiments of the invention;

FIG. 6 comprises a block diagram as configured in accordance with various embodiments of the invention; and

FIG. 7 comprises a block diagram as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the arts will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, pursuant to these various embodiments, a plurality of established Layer 3 Internet Protocol socket connections are aggregated with respect to such Layer 3 Internet Protocol connections. In a preferred approach this comprises not aggregating these socket connections with respect, in particular, to corresponding Layer 2 connections. These connections can comprise secure connections if desired though that is not required. In a more particular embodiment these socket connections serve to receive data packets as correspond to point-of-service transactions that require authorization.

In a preferred approach, a plurality of candidate transaction protocols are provided (which are different from one another). One such candidate transaction protocol is selected and used to facilitate compatible communications for each of the socket connections. In addition, and again pursuant to a preferred approach, a host transaction protocol is provided. So configured, communications as have been received from a given socket using a corresponding selected transaction protocol are translated to a host-compatible communication using the host transaction protocol.

So configured, Internet Protocol-based transaction communications as are sourced by any of a wide variety and number of point-of-service terminals are readily converted to a host transaction protocol and are further preferably aggregated as well. This, in turn, readily accommodates present physical, logical, and protocol requirements of legacy infrastructure (such as transaction processing host servers) thereby permitting continued deployment and use of a highly valuable existing resource notwithstanding a widespread shift to an all-Internet Protocol solution for point-of-service terminals.

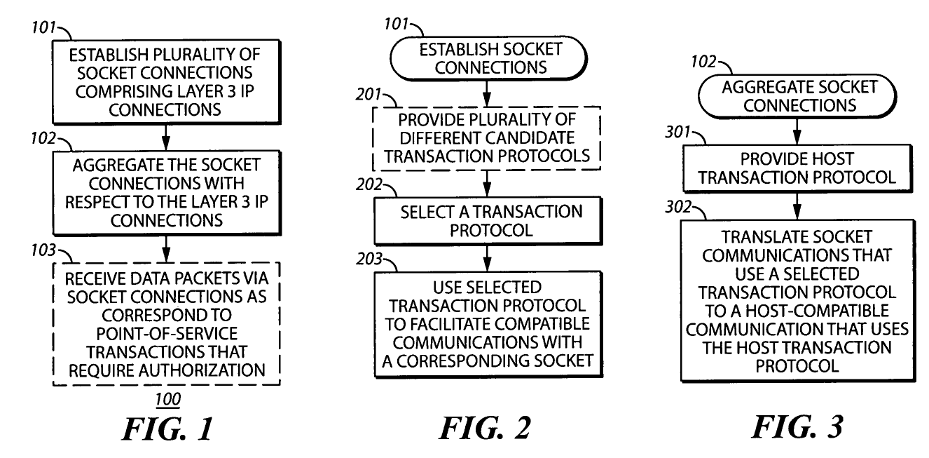

These and other benefits may become clearer upon making a thorough review and study of the following detailed description. Referring now to the drawings, and in particular to FIG. 1, an exemplary process 100 provides for establishment 101 of a plurality of socket connections comprising, at least in part, Layer 3 Internet Protocol connections. Those skilled in the art will recognize and understand that these socket connections can comprise any presently known or hereafter developed socket connections. As an illustration of this point, present examples include both Transmission Control Protocol (TCP) socket connections and User Datagram Protocol (UDP) socket connections.

These socket connections may comprise, if desired, secure connections as are known in the art. For example, these socket connections may comprise a Secure Socket Layer (SSL) connection, an Internet Protocol Security (IPSec) connection, or such other secure connection as may be presently known or hereafter developed.

With momentary reference to FIG. 2, establishing 101 these socket connections can comprise, in a preferred though optional approach, optionally providing 201 a plurality of different candidate transaction protocols from which particular transaction protocols can later be selected as described herein. These candidate transaction protocols are preferably different from one another and can vary, for example, with respect to packet formatting, packet verification, packet receipt acknowledgement, packet forwarding, and/or packet buffering, to note but a few. Transaction protocols are known in the art and others will no doubt be developed in the future. Because of this, and further in view of the fact that these teachings are not particularly sensitive with respect to selection of any particular transaction protocol or protocols, further elaboration regarding such transaction protocols will not be provided here.

A particular transaction protocol is then selected 202 from amongst the plurality of candidate transaction protocols to provide a resultant selected transaction protocol. That selected protocol is then used 203 to facilitate compatible communications with a given corresponding socket. As an over-simplified example, in an application setting featuring only two socket connections, a first transaction protocol may be selected for use with a first one of the two socket connections while a second, different transaction protocol is selected for use with the remaining socket connection.

The transaction protocols are preferably each selected to ensure compatible communications with, in this case, corresponding point-of-service terminals. So configured, any of a wide variety of point-of-service terminals are readily accommodated notwithstanding potentially significant differences with respect to their native ability to support or otherwise utilize a given specific transaction protocol.

Referring again to FIG. 1, this process 100 then aggregates 102 this plurality of socket connections with respect to their Layer 3 Internet Protocol connections. Those skilled in the art will recognize and understand that references herein to Layer 3 refer to the Open System Interconnection (OSI) model which specifies 7 layers that define a networking framework. Layer 3 refers specifically to a layer that provides switching and routing technologies, which create logical paths, often referred to as virtual circuits, for transmitting data from one node to another. Routing and forwarding are characterizing functions of Layer 3, as well as addressing, internetworking, error handling, congestion control, and packet sequencing.

In a preferred embodiment, this aggregation occurs with respect to the Layer 3 Internet Protocol connections but not with respect to corresponding Layer 2 connections. Those skilled in the art will recognize and understand that at this layer, data packets are encoded and decoded into bits. A Layer 2 connection furnishes transmission protocol knowledge and management and handles errors in the physical layer, flow control, and frame synchronization. The Layer 2 is typically divided into two sublayers: The Medium Access Control (MAC) layer and the Logical Link Control (LLC) layer. The MAC sublayer typically controls how an element, such as a computer, on the network gains access to data and permission to transmit. The LLC sublayer typically controls frame synchronization, flow control, and error checking.

With momentary reference now to FIG. 2, this aggregation 102 can further optionally but preferably comprise provision 301 of a host transaction protocol and translation 302 of a communication as has been received from a corresponding socket using a corresponding selected transaction protocol as described above to a host-compatible communication using the host transaction protocol. The host transaction protocol will typically be that protocol used by a given selected host server as comprises, for example, an authorization element having the means and authority to authorize a given point-of-service transaction. In a typical deployment this host transaction protocol will therefore often comprise a legacy protocol native to a given existing host for a corresponding authorized service.

So configured, and referring again to FIG. 1, data packets as correspond to various point-of-service transactions (which require, for example, authorization such as a point-of-sale transaction) are readily received 103 via this provided plurality of socket connections and then, in a preferred approach, aggregated to facilitate subsequent submission to an authorization entity such as a host server. In particular, communications from a plurality of point-of-service terminals (ranging, for example, from dozens to thousands of such terminals for a given enabling platform), each using a corresponding transaction protocol which may well differ from terminal to terminal, are translated into a common host-compatible transaction protocol and thereby aggregated for submission to a corresponding host recipient.

The reverse, of course, is then also readily accommodated. Communications as sourced by the host (including authorization messages, acknowledgements, and so forth) using the host-compatible transaction protocol are translated into a possibly different transaction protocol as corresponds to the capabilities and requirements of a corresponding intended recipient (such as a particular point-of-service terminal).

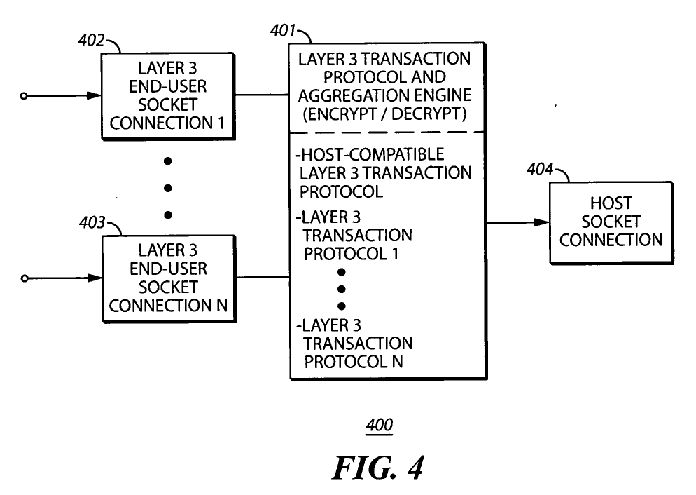

Those skilled in the art will appreciate that the above-described processes are readily enabled using any of a wide variety of available and/or readily configured platforms, including partially or wholly programmable platforms as are known in the art or dedicated purpose platforms as may be desired for some applications. Referring now to FIG. 4, an illustrative approach to such a platform will now be provided.

An exemplary Layer 3 Internet Protocol connection aggregation apparatus 400 may comprise a Layer 3 translation protocol and aggregation engine 401 having, in a preferred embodiment, a plurality of Layer 3 transaction protocols that are different from one another as suggested above. This plurality of Layer 3 transaction protocols will preferably include at least one host-compatible Layer 3 transaction protocol in addition to a plurality of Layer 3 transaction protocols as may be used to accommodate a variety of point-of-sale terminals. This engine 401 is preferably configured and arranged to convert an incoming communication that uses a particular one of the plurality of Layer 3 transaction protocols into a Layer 3 aggregated outgoing communication that uses the host-compatible Layer 3 transaction protocol. This, in turn, then serves to facilitate compatible communication exchanges between multiple end users (such as various point-of-service terminals) and, for example, an authorization host.

If desired, this Layer 3 transaction protocol and aggregation engine 401 can further be configured and arranged to facilitate decrypting and encrypting such communications. Various encryption techniques and methodologies are known in the art and others will no doubt be developed in the future. For this reason, and further because these teachings are not particularly sensitive to the selection and use of any particular approach to security, further elaboration will not be presented here for the sake of brevity and the preservation of narrative focus.

In a preferred approach, and viewed logically for the sake of clarity, an exemplary Layer 3 Internet Protocol connection aggregation apparatus 400 will further comprise a plurality of logical Layer 3 end-user socket connections (represented here by a first through an Nth socket connection 402 and 403, where N is any integer greater than “1”) that are, in turn, each operably coupled to the aforementioned Layer 3 transaction protocol and aggregation engine 401. These socket connections can be as described above (for example, these socket connections may comprise non-secure connections or secure connections as may be desired by a particular system designer or operator) and are coupled, in an exemplary embodiment, to receive incoming communications as comprise a point-of-service transaction (such as a point-of-sale transaction) communication that requires authorization.

Similarly, a host socket connection 404 also operably couples to the Layer 3 transaction protocol and aggregation engine 401 and serves, for example, to facilitate provision of the aforementioned outgoing communication that is aggregated with respect to Layer 3 but not aggregated, in a typical and preferred embodiment, with respect to Layer 2.

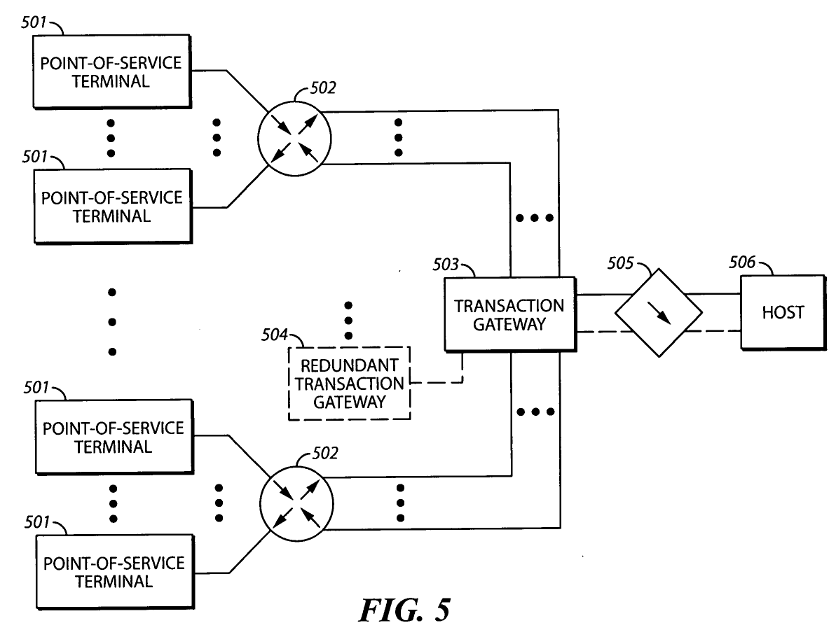

Referring now to FIG. 5, such a Layer 3 transaction protocol and aggregation engine can be viewed as a transaction gateway 503. If desired, one or more additional redundant transaction gateways 504 can be provided to serve in the event of failure of the transaction gateway 503 or any other eventuality that precludes present availability of the latter. This transaction gateway 503 couples as described to a plurality of socket connections represented here by routers 502 as are generally well-understood in the art. Each such router 502 can itself typically be expected to support thousands of individual point-of-service terminals 501 through provision of an Internet Protocol socket for each such point-of-service terminal. Two such routers 502 (and two point-of-service terminals 501 per each router 502) are depicted in the illustration for the sake of simplicity and clarity; those skilled in the art will understand that a typical deployment will more likely comprise dozens, hundreds, or even thousands of such routers, and potentially millions of such point-of-service terminals.

As depicted, the transaction gateway 503 can also couple to at least one host 506 via an element 505 such as a switch, a hub, and/or a router as are known in the art and as may be selected based upon the particular needs and/or constraints of a given network. So configured, this element 505 serves, in this embodiment, to establish a persistent socket connection as between the transaction gateway 503 and the host 506.

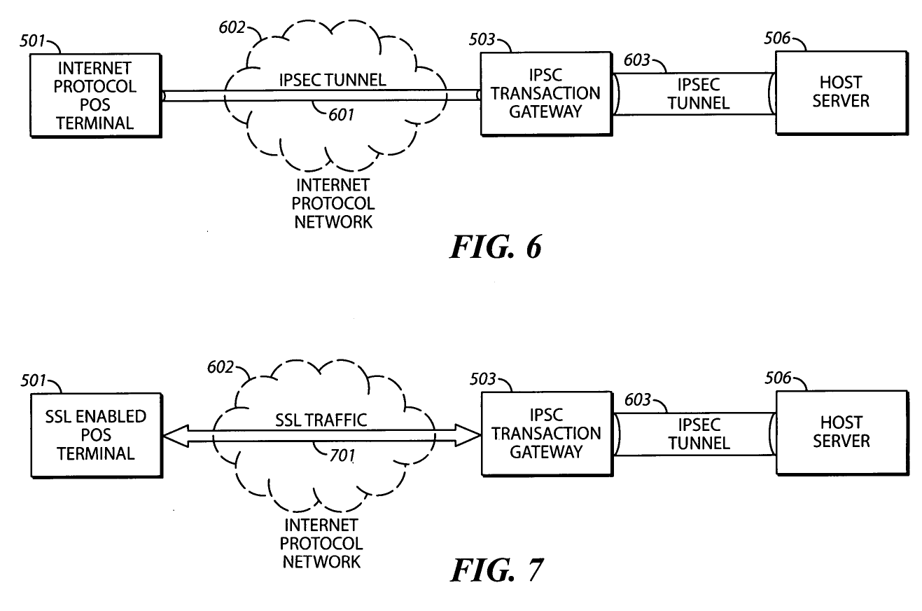

FIG. 6 depicts a more specific illustrative embodiment. Here, a given Internet Protocol point-of-service terminal 501 couples via in Internet Protocol Security (IPSec) tunnel 601 (traversing, for example, an extranet such as an Internet Protocol network 602) to an Internet Protocol Socket Concentrator (IPSC) transaction gateway 503 using a first transaction protocol. The transaction gateway 503 then couples via another Internet Protocol Security tunnel 603 (perhaps having, in a preferred embodiment, a larger carrying capacity than the earlier mentioned tunnel 601) to a corresponding host server 506. Referring now to FIG. 7, it can be further seen that a Secure Socket Layer enabled point-of-service terminal 501 can also couple to the transaction gateway 503 via, in this instance, corresponding Secure Socket Layer traffic 701 as traverses, for example, an Internet Protocol network 602 of choice. Notwithstanding this different choice of security protocol (i.e., Secure Socket Layer as versus the earlier noted Internet Protocol Security approach) the transaction gateway 503 will serve to translate and aggregate the incoming communications and provide them to the host server 506 via the host server's native and accommodated transaction protocol.

Using presently available technology such a transaction gateway might be expected to readily aggregate upon to a minimum of 2,000 such connections. Pursuant to one useful approach the transaction protocols supported by the transaction gateway will include VISAI and VISAII as are known in the art to thereby facilitate meaningful interaction between legacy host servers and newer Internet Protocol based point-of-service terminals. So configured, the transaction gateway can establish Transfer Control Protocol connections with given Internet Protocol host servers using VISA transaction protocols and provide VISA specified data for transactions as are carried out between the host server and various Internet Protocol point-of-service terminals.

The aforementioned aggregation permits the host servers to maintain only a limited number of Transfer Control Protocol connections as multiple point-of-service connections can be aggregated and hence multiplexed using a single connection.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. A method comprising:
establishing a plurality of socket connections comprising, at least in part, Layer 3 Internet Protocol connections;
aggregating the plurality of socket connections with respect to the Layer 3 Internet Protocol connections.

2. The method of claim 1 wherein aggregating the plurality of socket connections with respect to the Layer 3 Internet Protocol connections further comprises not aggregating the plurality of socket connections with respect to corresponding Layer 2 connections.

3. The method of claim 2 wherein the plurality of socket connections further comprise secure connections.

4. The method of claim 3 wherein the secure connections comprise at least one of secure socket layer (SSL) and Internet Protocol Security (IPSEC) secure connections.

5. The method of claim 3 further comprising:
receiving data packets via the plurality of socket connections as correspond to point-of-service transactions that require authorization.

6. The method of claim 5 wherein the point-of-service transactions comprise point-of-sale transactions.

7. The method of claim 5 wherein establishing a plurality of socket connections comprising, at least in part, Layer 3 Internet Protocol connections further comprises, for each of the plurality of socket connections:
selecting a particular transaction protocol, from amongst a plurality of candidate transaction protocols that are different from one another, to provide a selected transaction protocol;
using the selected transaction protocol to facilitate compatible communications with a corresponding socket.

8. The method of claim 7 wherein the selected transaction protocol specifies protocol with respect to at least one of:
packet formatting;
packet verification;
packet receipt acknowledgement;
packet forwarding;
packet buffering.

9. The method of claim 7 wherein aggregating the plurality of socket connections with respect to the Layer 3 Internet Protocol connections further comprises;
providing a host transaction protocol;
translating communications as have been received from a corresponding socket using a corresponding selected transaction protocol to a host-compatible communication using the host transaction protocol.

10. The method of claim 1 wherein establishing a plurality of socket connections further comprises establishing at least one of:
a plurality of Transmission Control Protocol socket connections;
a plurality of User Datagram Protocol socket connections.

11. A Layer 3 Internet Protocol connection aggregation apparatus comprising:
a Layer 3 transaction protocol and aggregation engine having a plurality of Layer 3 transaction protocols that are different from one another including, in part, a host-compatible Layer 3 transaction protocol, wherein the Layer 3 transaction protocol and aggregation engine is arranged and configured to convert an incoming communication that uses a particular one of the plurality of Layer 3 transaction protocols into a Layer 3-aggregated outgoing communication that uses the host-compatible Layer 3 transaction protocol;
a plurality of logical Layer 3 end-user socket connections that are operably coupled to the Layer 3 transaction protocol and aggregation engine;
a host socket connection that is operably coupled to the Layer 3 transaction protocol and aggregation engine.

12. The Layer 3 Internet Protocol connection aggregation apparatus of claim 11 wherein the plurality of logical Layer 3 end-user socket connections further comprise secure socket connections.

13. The Layer 3 Internet Protocol connection aggregation apparatus of claim 12 wherein the secure socket connections further comprise socket connections that are compatible with at least one of secure socket layer (SSL) and Internet Protocol Security (IPSEC) secure connections.

14. The Layer 3 Internet Protocol connection aggregation apparatus of claim 12 wherein the host socket connection further comprises at least one of:
a secure Transmission Control Protocol/Internet Protocol socket connection;
a non-secure connection.

15. The Layer 3 Internet Protocol connection aggregation apparatus of claim 11 wherein the incoming communication comprises a point-of-service transaction communication that requires authorization.

16. The Layer 3 Internet Protocol connection aggregation apparatus of claim 15 wherein the point-of-service transaction communication comprises a point-of-sale transaction communication.

17. The Layer 3 Internet Protocol connection aggregation apparatus of claim 12 wherein the Layer 3-aggregated outgoing communication further comprises an outgoing communication that is not aggregated with respect to Layer 2.

18. The Layer 3 Internet Protocol connection aggregation apparatus of claim 12 wherein the Layer 3 transaction protocol and aggregation engine further comprises means for translating communications with respect to Layer 3 transaction protocols to thereby facilitate compatible communication exchanges between multiple end users and an authorization host.

19. The Layer 3 Internet Protocol connection aggregation apparatus of claim 18 wherein the Layer 3 transaction protocol and aggregation engine further comprises means for decrypting and encrypting communications from and to the multiple end users and the authorization host to thereby facilitate secure communications between these elements.
